(19) United States
(12) Patent Application Publication
(10) Pub. No.: US 2026/0264346 A1
(43) Pub. Date: Sep. 10, 2026

(54) MOLDING

(71) Applicant: YAMAHA HATSUDOKI KABUSHIKI KAISHA, Iwata-shi (JP)

(72) Inventors: Tomoki ITO, Shizuoka (JP); Kenjiro FUJII, Shizuoka (JP); Takeshi OISHI, Shizuoka (JP)

(21) Appl. No.: 19/662,990

(22) Filed: Apr. 29, 2026

Related U.S. Application Data
(63) Continuation-in-part of application No. PCT/JP2023/039321, filed on Oct. 31, 2023.

(51) Int. Cl. B29C 70/22; B29K 105/08; D04B 1/06

(52) U.S. Cl. CPC B29C 70/222; D04B 1/06; B29K 2105/0836; D10B 2505/02

(57) ABSTRACT

A molding of a fiber-reinforced composite material, including: a resin material that is meltable or decomposable; and a fiber material that is continuous between a start end portion thereof and a terminal end portion thereof, and forms a shape that is unravelable by taking an end portion thereof that is either the start end portion or the terminal end portion. The fiber material is buried in the resin material. The molding has a fiber low-density portion in which a density of the fiber material is lower than in the rest of the molding. The end portion of the fiber material is positioned in the fiber low-density portion so as to be identifiable.

### CROSS-REFERENCE TO RELATED APPLICATION(S)

This is a continuation-in-part application of International Application PCT/JP2023/39321, filed on Oct. 31, 2023. The contents of the applications are incorporated herein by reference.

### TECHNICAL FIELD

The present teaching relates to a molding of a fiber-reinforced composite material.

### BACKGROUND ART

Conventionally provided is a molding of a fiber-reinforced composite material having a fiber material such as carbon fibers or natural fibers as a reinforcement. In recent times, from the viewpoint of effective use of resources, the demand for recycling a fiber material in a fiber-reinforced composite material is increasing. If it is possible to recover a fiber material while maintaining the length the fiber material had when being molded by avoiding its segmentation as much as possible, the application of the fiber material when it is reused can be expanded, so that the efficiency of recycling the fiber material can be increased.

PTL 1 discloses a fiber-reinforced composite material with a tape material. The technique of PTL 1 makes it possible to recover a fiber material while maintaining its length. In the fiber-reinforced composite material of PTL 1, component data about a component is stored in a radio frequency identification (RFID) or in a 3D code, and, for example, an RFID tag including the data is provided to a molding, so that a position where the tape material is to be recovered is identifiable. The technique of PTL 1 makes it possible to identify the position where the fiber material is to be recovered, by using an RFID reader or the like.

### CITATION LIST

### Patent Literature

PTL 1: Japanese Translation of PCT International Application Publication No. 2019-529177

### SUMMARY OF INVENTION

### Technical Problem

Here, if a fiber material is recovered without being segmented, products in an expanded range can be molded by taking advantage of the length of the fiber material. Thus, in recovering a fiber material, it is desirable to recover the fiber material while maintaining the length the fiber material had when being molded by avoiding its segmentation as much as possible, in order to expand the application in reuse. In a fiber-reinforced composite material, fiber materials (such as knitting yarns or tape materials) are densely packed, to form a framework of a molding, and it is not easy to find an end portion of the fiber material after a resin material is melted or decomposed. On the other hand, there is a demand that when a resin material is melted or decomposed for recovery of fiber materials, the efficiency of a recovering operation be improved by making it easy to recover fiber materials by enabling end portions of the fiber materials to be quickly found without use of any tool (such as an RFID reader).

An object of the present teaching is to provide a molding of a fiber-reinforced composite material in which the fiber material can be easily recovered and enables broader use when reused.

### Solution to the Problem

The inventors of the present application conducted studies about a molding of a fiber-reinforced composite material from which fiber materials are able to be easily recovered after melting or decomposition of a resin material. Here, the molding of the fiber-reinforced composite material encompasses a molding obtained by molding a lamination of prepregs each made of a tape material preliminarily impregnated with a resin material, and a molding obtained by molding a knitted substrate impregnated with a resin material, the knitted substrate being obtained by knitting a knitting yarn that serves as a reinforcement. In a case of the molding made of a lamination of prepregs, after the resin material is melted or decomposed, the tape materials overlap each other so that end portions cannot be found easily. In a case of having the knitted substrate serve as a reinforcement, a tangle of the knitting yarn forms a stitch, and therefore after the resin material is melted or decomposed, an end portion of the knitting yarn gets into the stitch so that finding the end portion is not easy.

As a result of studies, the inventors of the present application arrived at the knowledge that providing a region in which the density of fiber materials is lower than that in another region and arranging an end portion of a fiber material in the region so that the end portion can be identified makes it easy to find the end portion of the fiber material after a resin material is melted or decomposed. To be specific, in a molding configured such that a fiber material can be recovered therefrom by pulling an end portion (for example, a terminal end portion) of a fiber material and thus unraveling a stitch or a laminated condition of the fiber material after a resin material is melted or decomposed, a region in which the density of fiber materials is lower than that in the other region is provided, and an end portion is arranged in that region so that the end portion of the fiber material arranged in that region can be identified after the resin material is melted or decomposed. Such a configuration makes it easy to find the end portion after the resin material is melted or decomposed. Consequently, the inventors of the present application arrived at the knowledge that the end portion of the fiber material is able to be found quickly without use of any tool or the like, which reduces a workload in looking for the end portion of the fiber material, thus improving the efficiency of a fiber material recovering operation, for easy recovery of fiber materials. Based on this knowledge, the teaching of the present application was accomplished.

In an aspect of the present teaching, which is provided based on the knowledge described above, a molding may adopt the following configuration.

A molding (1) is a molding of a fiber-reinforced composite material including: a resin material serving as a base material, the resin material being able to be melted or decomposed; and a fiber material serving as a reinforcement, the fiber material being buried in the resin material while being continuous so as to form a shape according to the resin material. The molding includes a fiber low-density portion in which the density of the fiber material in the molding is lower as compared to in another portion. The fiber material is buried in the resin material in such a manner that an end portion that is at least either one of a start end portion or a terminal end portion of the fiber material is positioned in the fiber low-density portion, to enable the end portion positioned in the fiber low-density portion to be identified after the resin material is melted or decomposed, and to enable the shape formed by the fiber material to be unraveled and the fiber material to be recovered by taking out the end portion positioned in the fiber low-density portion after the resin material is melted or decomposed.

In the molding (1) above, after the resin material is melted or decomposed to expose the fiber material, the end portion (for example, the terminal end portion) of the fiber material is taken out, so that a stitch or a laminated condition of the fiber material can be unraveled, to enable the fiber material to be recovered with its length maintained, and also to enable the end portion of the fiber material to be found quickly without use of any tool or the like. For example, if the density of a fiber material is uniform, it is difficult to find an end portion of the fiber material because it is blended in with other portions of the fiber material. In this regard, in the molding (1) above, the end portion of the fiber material is arranged in the portion (fiber low-density portion) in which the density of the fiber material is lower in such a manner that the fiber material is identifiable. Consequently, the end portion of the fiber material is less likely to be blended in with other portions of the fiber material, and therefore finding the end portion is easy. Accordingly, in the molding (1) above, a workload is reduced in looking for the end portion of the fiber material after the resin material is melted or decomposed, and thus the efficiency of a fiber material recovering operation can be improved. Consequently, the molding (1) above allows the fiber material to be recovered easily, and also enables the fiber material to be recovered with its length maintained so that the application of the fiber material in reuse can be expanded, thus providing an increased efficiency of recycling.

In an aspect of the present teaching, the molding may adopt the following configuration.

(2) In the molding according to (1) above, the fiber low-density portion includes a protruding portion protruding on a surface of the molding, and the fiber material is configured such that the end portion of the fiber material is positioned in the protruding portion protruding on the surface of the molding, to enable the end portion positioned in the fiber low-density portion to be identified after the resin material is melted or decomposed, and to enable a position of the end portion positioned in the fiber low-density portion to be identified before the resin material is melted or decomposed.

The molding (2) above makes it easy to grasp the position of the end portion at a stage before the resin material is melted or decomposed. Consequently, in the molding (2) above, the workload in looking for the end portion for the recovery of the fiber material is further reduced, and the ease of recovery of the fiber material is enhanced.

In an aspect of the present teaching, the molding may adopt the following configuration.

(3) In the molding according to (2) above, the fiber material is configured such that the end portion of the fiber material is positioned in the protruding portion protruding with a hook shape or a ring shape on the surface of the molding, to enable the end portion positioned in the fiber low-density portion to be identified after the resin material is melted or decomposed, and to enable a position of the end portion positioned in the fiber low-density portion to be identified before the resin material is melted or decomposed.

In the molding (3) above, it is possible to attach a fastener or the like to the protruding portion (a portion with the hook shape or the ring shape) before the resin material is melted or decomposed. In the molding (3) above, if a fastener or the like is attached to the protruding portion before the resin material is melted or decomposed, prompt setting of the end portion of the fiber material in a winding machine is enabled after the resin material is melted or decomposed. Consequently, in the molding (3) above, the ease of recovery of the fiber material is further enhanced.

In an aspect of the present teaching, the molding may adopt the following configuration.

(4) In the molding according to any of (1) to (3) above, the fiber material is a knitting yarn with a filamentous shape, and the knitting yarn forms a knitted substrate in which stitches are continuously arranged, each of the stitches being formed by shaping the knitting yarn into a loop, and the knitting yarn is buried in the resin material in such a manner that the terminal end portion is positioned in the fiber low-density portion in which the density of the knitting yarn in the molding is lower as compared to in the other portion, to enable the terminal end portion positioned in the fiber low-density portion to be identified after the resin material is melted or decomposed, and to enable the knitted substrate to be unraveled and the knitting yarn to be recovered by taking out the terminal end portion positioned in the fiber low-density portion after the resin material is melted or decomposed.

In the molding (4) above, after the resin material is melted or decomposed to expose the knitting yarn, the terminal end portion of the knitting yarn is taken out, so that the stitch of the knitted substrate formed by the knitting yarn is unraveled, to enable the knitting yarn to be recovered with its length maintained, and also to enable the end portion of the knitting yarn to be found quickly without use of any tool or the like. For example, if the density of the knitting yarn is uniform, it is difficult to find an end portion of the knitting yarn because it is blended in with other portions of the knitting yarn. In this regard, in the molding (4) above, the terminal end portion of the knitting yarn is arranged in the portion (fiber low-density portion) in which the density of the knitting yarn is lower. Consequently, the terminal end portion of the fiber material is less likely to be blended in with other portions of the fiber material, and therefore finding the terminal end portion is easy.

In more detail, in a case of using a knitted substrate in which a knitting yarn is knitted as a reinforcement, stitches are formed by the knitting yarn being tangled, which makes a terminal end portion blended in with the stitches, so that finding terminal end portion is difficult. In the molding (4) above, on the other hand, the density of the knitting yarn is lower in surroundings of the terminal end portion, which makes it more likely that a difference in appearance occurs between the surroundings of the terminal end portion and the other portion. Accordingly, in the molding (4) above, a workload in looking for the terminal end portion of the knitting yarn after the resin material is melted or decomposed is reduced, and thus the efficiency of a knitting yarn recovering operation can be improved. Consequently, the molding (4) above allows the knitting yarn to be recovered easily, and also enables the knitting yarn to be recovered with its length maintained so that the application of the knitting yarn in reuse can be expanded, thus providing an increased efficiency of recycling.

In the molding (4) above, the knitted substrate has a stretchability, and thus is easy to fit to a mold, which causes less wrinkles at a time of molding. Accordingly, the molding (4) above can provide an improved work efficiency in setting the substrate to the mold, and further can suppress occurrence of wrinkles, as compared to a case of cutting a fabric such as textile and setting the fabric to a mold.

In an aspect of the present teaching, the molding may adopt the following configuration.

(5) In the molding according to (4) above, the fiber low-density portion includes a portion having a stitch larger than the stitch of the other portion, and the knitting yarn is configured such that the terminal end portion is positioned in the portion having the stitch larger than the stitch of the other portion, to enable the terminal end portion positioned in the fiber low-density portion to be identified after the resin material is melted or decomposed.

In the molding (5) above, in the surroundings of the terminal end portion, the stitches are rough, and therefore finding and grasping the terminal end portion is easy. To be specific, since stitches of different sizes appear to make different patterns, which makes the fiber low-density portion easy to see, and moreover since the knitting yarn is sparse in the surroundings of the terminal end portion (in fiber low-density portion), accidentally grasping a portion other than the terminal end portion can be suppressed. Consequently, the molding (5) above makes it easy to find the terminal end portion, thus providing an improved work efficiency in recovering the fiber material.

In an aspect of the present teaching, the molding may adopt the following configuration.

(6) In the molding according to (4) or (5) above, the knitting yarn is configured such that the terminal end portion having a knot created by tying the knitting yarn is positioned in the fiber low-density portion in which the density of the knitting yarn in the molding is lower as compared to in the other portion, to enable the terminal end portion positioned in the fiber low-density portion to be identified after the resin material is melted or decomposed.

In the molding (6) above, fraying of the terminal end portion and a portion near the terminal end portion of the knitting yarn can be suppressed, and grasping the terminal end portion is easy. Consequently, in the molding (6) above, a portion of the knitting yarn that becomes unable to use due to fraying is reduced, and moreover a further improved work efficiency in recovering the knitting yarn can be obtained.

In an aspect of the present teaching, the molding may adopt the following configuration.

(7) In the molding according to (6) above, the knitting yarn is configured such that the terminal end portion having an overhand knot that is the knot created at the base of a ring portion of the knitting yarn formed by shaping the knitting yarn into a ring is positioned in the fiber low-density portion in which the density of the knitting yarn in the molding is lower as compared to in the other portion, to enable the terminal end portion positioned in the fiber low-density portion to be identified after the resin material is melted or decomposed.

In the molding (7) above, the terminal end portion of the knitting yarn is further easier to find, and can be easily caught on a winding machine or the like. Consequently, the molding (7) above can provide a further improved work efficiency in recovering the knitting yarn for recycling.

In an aspect of the present teaching, the molding may adopt the following configuration.

(8) In the molding according to any of (4) to (7) above, the knitting yarn is configured such that the knitting yarn forms a knitted substrate having a three-dimensional shape in which stitches are continuously arranged, each of the stitches being formed by shaping the knitting yarn into a loop, and the terminal end portion is positioned in the fiber low-density portion in which the density of the knitting yarn in the molding is lower as compared to in the other portion, to enable the terminal end portion positioned in the fiber low-density portion to be identified after the resin material is melted or decomposed.

In the molding (8) above, it is possible that the knitted substrate is formed according to the shape of the molding. Consequently, in the molding (8) above, as compared to a case where plural knitted substrates are arranged as a reinforcement and a case where textile is adopted as a reinforcement, the time and effort in setting the knitted substrate to a mold can be reduced, and unevenness of a substrate can be avoided or reduced.

In a case where a flat cloth material such as textile is adopted as a reinforcement, it is necessary to cut the textile according to the three-dimensional shape of a molding, and offcuts are produced. In the molding (8) above, the knitted substrate, which is able to be formed with a shape according to the shape of a molded product, is used, and therefore the amount of offcuts can be reduced as much as possible. Consequently, in the molding (8) above, the yield of the material can be improved.

The fiber material included in the molding of the present teaching is simply required to be one that is usable as a reinforced fiber material. As the fiber material included in the molding of the present teaching, various choices are available such as a natural fiber, a carbon fiber, and an aramid fiber. The molding includes at least one fiber material, for example.

The “resin material being able to be melted or decomposed” encompasses a resin material capable of being melted by heat, a resin material capable of being decomposed by chemical decomposition with chemicals, and a resin material capable of being decomposed by superheated steam decomposition, for example. Examples of the resin material capable of being melted by heat include a thermoplastic resin. Examples of the resin material capable of being decomposed by chemical decomposition with chemicals or by superheated steam decomposition include a thermosetting resin. The resin material is simply required to be one that is able to be recovered after melted or decomposed, for example. As the thermoplastic resin, various choices are available such as polyethylene, polypropylene, an ABS resin, an acrylic resin, and polyamide. As the thermosetting resin, various choices are available such as an epoxy resin, a vinyl ester resin, and an unsaturated polyester resin.

The proportions (the volume or weight proportions) of the resin material and the fiber material in the molding of the present teaching can be selected as appropriate in accordance with the thickness and size of the molding, the method for manufacturing the molding, and the like.

The wording “so as to form a shape according to the resin material” means that the fiber material forms a shape (framework) of the molding, for example. This means not that the fiber material is partially used in the molding but that the fiber material forms the outer shape of the molding, for example. For example, in a case where the fiber material forms a knitting yarn substrate in which a knitting yarn is knitted, the wording means that the knitted substrate has a shape that is according to the shape of a molded product. In a case where the fiber material is a knitting yarn, the wording means that the knitting yarn (knitted substrate) in the molding forms a shape that is according to the outer shape formed by the resin material. For example, in a case where the fiber material is a tape material, the wording means that the tape material forms a shape that is according to the outer shape of a molded product.

The wording “being continuous” means that the fiber material is continuous (has an endless shape) from its start end to its terminal end, for example. The wording “being continuous” means both a case where it is a single fiber material that is seamless and a case where it includes a portion (seam) at which plural fiber materials are connected, to have a continuous length, for example. Thus, the “fiber material being continuous” encompasses a fiber material having a seam in its middle, for example. The fiber material is simply required to have a configuration that is able to be handled as a single piece, for example. The fiber material may be a single piece, or may be a bundle of plural pieces, for example.

The “end portion of the fiber material” means at least one of the start end portion or the terminal end portion of the fiber material, for example. Thus, a case where “an end portion that is at least either one of a start end portion or a terminal end portion of the fiber material is positioned in the fiber low-density portion” encompasses a case where the start end portion is positioned in the fiber low-density portion, a case where the terminal end portion is positioned in the fiber low-density portion, and a case where the start end portion is positioned in the fiber low-density portion while the terminal end portion is positioned in the fiber low-density portion, for example.

The “start end portion” is an end portion out of the opposite end portions that serves as a portion at which the fiber material starts in the substrate formation step of forming the fiber material (e.g., a knitting yarn) as the knitted substrate or in the step of molding the fiber material (e.g., a tape material) into a shape according to a mold, for example. The “terminal end portion” is an end portion out of the opposite end portions that serves as a portion at which the fiber material ends in the substrate formation step of forming the fiber material as the knitted substrate or in the lamination step of laminating the fiber materials, for example. For example, in a case where the fiber material is formed as a knitted substrate, taking out the terminal end portion or the start end portion makes the knitted substrate unraveled and return to the knitting yarn. For example, in a case where the fiber material is a tape material, the tape material, which forms the outer shape of a molding, is unraveled by taking out the terminal end portion or the start end portion.

The wording “the fiber material being buried in the resin material, to enable the shape formed by the fiber material to be unraveled and the fiber material to be recovered by taking out the end portion positioned in the fiber low-density portion after the resin material is melted or decomposed” means that the fiber material that is buried in the resin material while being continuous is configured such that the shape formed by the fiber material is unraveled by taking out the end portion after the resin material is melted or decomposed, for example. For example, in a case where the fiber material is a knitting yarn and the knitting yarn forms a knitted substrate, the wording means that by taking out the end portion (for example, the terminal end portion) after the resin material is melted or decomposed, stitches of the knitted substrate formed by the knitting yarn can be unraveled so that the knitting yarn returns to a filamentous shape, to thus enable recovery of the knitting yarn. For example, in a case where the fiber material is a tape material and the molding is obtained by molding the tape material into a shape according to the mold, the shape formed by the tape material can be unraveled by taking out the end portion after the resin material is melted or decomposed, to thus enable recovery of the tape material.

The “knitting yarn” is one having a filamentous shape (including a string shape) for forming the stitch of the knitted substrate, for example. The thickness of the knitting yarn can be selected as appropriate in accordance with the size or thickness of the molding, a knitting machine used, and the like, for example. Herein, something that is able to be knitted by a knitting machine is referred to as “knitting yarn” irrespective of its thickness. Thus, in this Description, the “knitting yarn with a filamentous shape” encompasses both a case of a commonly-called “filament” thickness and a case of a commonly-called “string” thickness.

The “knitted substrate” is one in which stitches are continuously arranged, each of the stitches being formed by shaping the knitting yarn into a loop, for example. More specifically, the knitted substrate is obtained by continuously shaping the knitting yarn into a loop, and furthermore threading the knitting yarn through the looped portion to form a loop shape, so that portions (stitches) created by the knitting yarn with loop shapes are continuously arranged to form a knitted fabric, for example. The knitted substrate can be molded by using a knitting machine, for example.

The “knitted substrate in which stitches are continuously arranged, each of the stitches being formed by shaping the knitting yarn into a loop” means that the fiber material, which is essential for forming the knitted substrate, is the knitting yarn, for example. The molding of the present teaching may include a reinforcement that does not form a stitch, for example. That is, the knitted substrate may be made of a single type of a fiber material, or may be made of two or more types of fiber materials, for example. The knitted substrate may be made only of the knitting yarn, or may include the knitting yarn and an inlay knitting yarn, for example. The knitted substrate may include still another filament material (such as a bias tape) in addition to the knitting yarn.

The number of knitted substrates included in the molding may be one, or may be more than one, for example. The knitted substrate included in the molding may be a single knitted substrate, for example. The molding of the present teaching may be molded with plural knitted substrates arranged so as to follow the shape of the molding, for example. The molding of the present teaching may be a lamination of plural knitted substrates, for example. The number of tape materials included in the molding may be one, or may be more than one, for example. The molding of the present teaching may be molded with a single tape material, or may be molded with plural tape materials, for example.

The “fiber low-density portion in which the density of the fiber material in the molding is lower as compared to in another portion” means that how densely the fiber material is packed in the molding (in a state before the resin material is melted or decomposed) is lower in the fiber low-density portion as compared to in another portion, for example. In other words, the “fiber low-density portion in which the density of the fiber material in the molding is lower as compared to in another portion” means that the fiber low-density portion is a portion in which the volume occupied by the fiber material relative to the volume of the molding is lower as compared to another portion, for example. In other words, for example, the boundary at which the fiber low-density portion is separated from another portion is where the density of the fiber material changes in a region of the molding containing the fiber material.

In more detail, it means that the fiber low-density portion is a portion in which the volume occupied by the fiber material is lower relative to all of the volumes (the volume of the molding) of the resin material, the fiber material, and other materials (such as a film material), for example. The aspect in which the density of the fiber material is low encompasses an aspect in which the fiber material is a knitting yarn, and stitches of the knitted substrate are partially large (stitches are partially rough) so that the density of the knitting yarn is partially low, for example. An aspect is also encompassed in which a hole having no stitch is formed in the knitted substrate, and a terminal end portion of the knitting yarn and therearound is included in the hole so that the density of the knitting yarn is lower in the hole than in another portion (portion where a stitch is formed), for example.

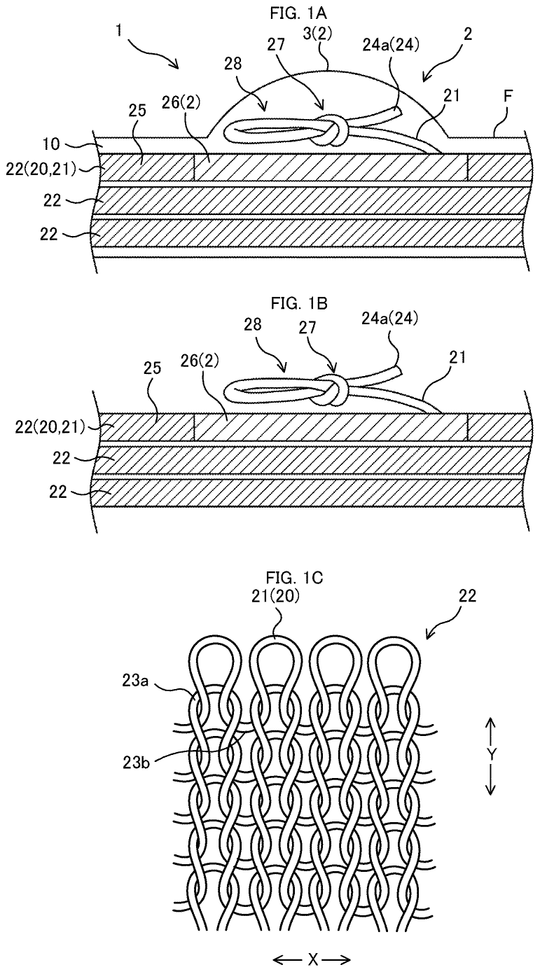

In a specific example, in a case where the fiber material is a knitting yarn, it may be conceivable that a terminal end portion of the knitting yarn is arranged in a protruding portion having a protruding shape in the fiber low-density portion, and a stitch near the terminal end portion is made larger as compared to that in another portion (see FIG. 1A), for example. In this configuration, the protruding portion includes no stitch and has a lower density of the knitting yarn as compared to another portion, and in addition, a portion having the larger stitch near the terminal end portion has a lower density of the knitting yarn as compared to a portion other than the fiber low-density portion. Thus, the density of the knitting yarn increases in the order of “protruding portion (fiber low-density portion)<portion having larger stitch (fiber low-density portion)<portion other than fiber low-density portion.”

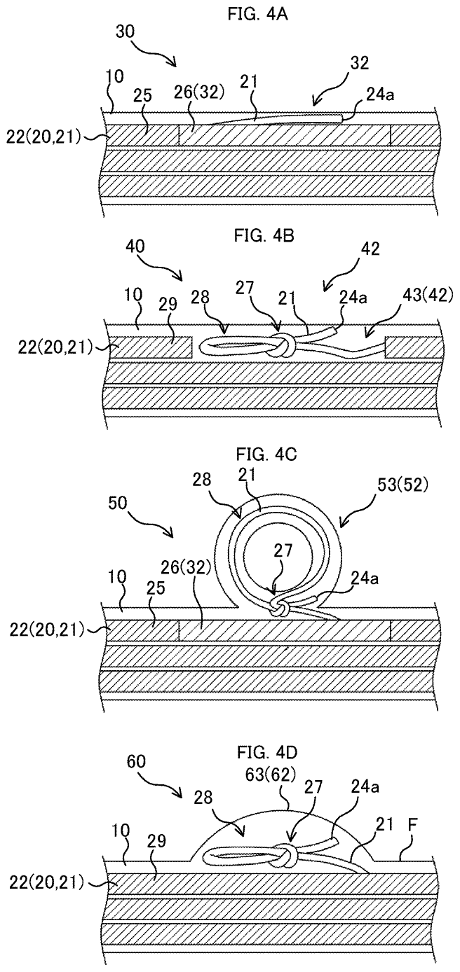

For example, in a case where the fiber material is a knitting yarn, it may be conceivable that a stitch is made larger in a portion (fiber low-density portion) where an end portion of the knitting yarn is arranged as compared to in another portion (see FIG. 4A). In this configuration, the density of the knitting yarn is lower in the fiber low-density portion than in another portion.

Furthermore, for example, in a case where the fiber material is a knitting yarn, it may be conceivable that a portion of the knitted substrate corresponding to a portion (fiber low-density portion) where an end portion of the knitting yarn is arranged has a hole where no stitch is present, and the terminal end portion of the knitting yarn is disposed in the hole (see FIG. 4B). In this configuration, the density of the knitting yarn is lower in the fiber low-density portion, because no stitch is present there.

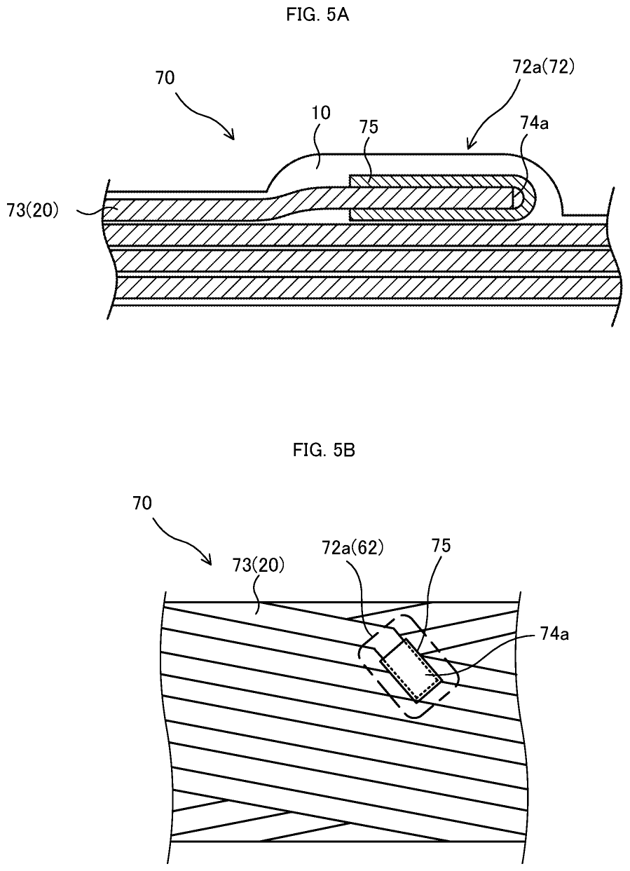

Furthermore, for example, in a case where the fiber material is a tape-shaped one (tape material), it may be conceivable that one or both of the opposite end portions of the tape material is or are covered with a film material or the like, and the amount of the resin material is increased in the vicinity of the end portion of the tape material (see FIG. 5A). In this configuration, the proportion (density) of the tape material in the molding is lower in a portion (fiber low-density portion) near the end portion of the tape material than in another portion. Thus, the density of the tape material increases in the order of “portion near end portion of tape material (fiber low-density portion) <another portion.” Here, as a material that covers the end portion of the tape material, various choices are available such as a resin film including a plastic film, a material similar to the tape material, and the like.

The fiber low-density portion may be provided only in the start end portion, may be provided only in the terminal end portion, or may be provided both in the start end portion and in the terminal end portion, for example. The fiber low-density portion may be, for example, characterized not only by having a lower density of the fiber material than another portion but also by having a tag or having a different color than another portion, for example. To the end portion of the fiber material, a tag may be attached, or a different color than another portion may be given.

The wording “configured to enable the end portion positioned in the fiber low-density portion to be identified after the resin material is melted or decomposed” means that the end portion, which was positioned in the fiber low-density portion before the resin material is melted or decomposed becomes able to be identified from another portion in a state after the resin material is melted or decomposed, for example.

The wording “configured to enable the end portion positioned in the fiber low-density portion to be identified after the resin material is melted or decomposed,” will now be explained with specific examples, namely, first example, second example, third example, and fourth example. In the first example, the second example, and the third example, a molding having a knitted substrate formed of a fiber material is illustrated as an example, and in the fourth example, a case in which a fiber material is a tape material, and the tape materials are laminated is illustrated as an example.

In the first example, for instance, in a case of a molding having a knitted substrate formed of a fiber material, it may be conceivable to provide a portion having a larger stitch than another portion, and enable an end portion to be positioned in the portion having the larger stitch after a resin material is melted or decomposed (see FIG. 1B, FIG. 4A, and FIG. 4C). This configuration makes it possible to identify the end portion and a portion (portion having the larger stitch) where the end portion is positioned from a stitch in another portion after the resin material is melted or decomposed.

In the second example, for instance, in a case of a molding having a knitted substrate formed of a fiber material, it may be conceivable to provide the knitted substrate with a hole where no stitch is present, and enable an end portion to be positioned in the hole after a resin material is melted or decomposed (see FIG. 4B). This configuration makes it possible to identify the end portion and the hole from another portion (a portion where a stitch is present) after the resin material is melted or decomposed.

In the third example, for instance, in a case of a molding having a knitted substrate formed of a fiber material, it may be conceivable to make an end portion (for example, an end portion having a knot) positioned on a surface of the knitted substrate, and enable the end portion to be positioned on the surface of the knitted substrate after a resin material is melted or decomposed (see FIG. 4D). This configuration makes it possible to identify the end portion of a knitting yarn from the knitted substrate after the resin material is melted or decomposed.

In the fourth example, for instance, in a case of a molding having a lamination of tape materials, a configuration may be conceivable in which the tape materials are, except their end portions, laminated at substantially constant intervals so as to extend in paths that have substantially the same angle, whereas the end portion of the tape material extends in a path that is bent and thus different from the paths of the other portions of the tape materials (see FIG. 5B). In this configuration, after a resin material is melted or decomposed, the other portions of the tape materials are laminated at substantially uniform intervals and angles, whereas the end portion forms an angle different from the angle formed by the other portions. Consequently, the other portions of the tape materials are able to be identified from the end portion.

The end portion of the knitting yarn may be covered with another member, for example. Examples of the covering the end portion of the knitting yarn with another member include attachment of a tube-shaped member and reinforcement with a tape material or the like. Such a configuration can suppress fraying of the end portion of the knitting yarn.

The “protruding portion” is a portion of the surface of the molding, the portion having a protruding shape, for example. Here, the surface of the molding means a surface of a superficial layer of the molding irrespective of whether it serves as the front surface or the back surface of a product, for example. The protruding portion may have any shape such as a dome shape formed by raising of the surface of the molding, a columnar shape formed by projecting of the surface of the molding, a hook shape formed by the surface of the molding, a ring shape formed by the surface of the molding, or the like.

The “other portion (another portion)” means, for example, a portion having a density of the fiber material, the density being applied across a wide range in the molding (the density being a standard density in most of the molding). For example, in a case where the fiber material is a knitting yarn, the “other portion” means a portion having a stitch with a size that is applied across the widest range in the molding (the standard stitch size in most of the molding). For example, in a case where the fiber material is a tape material, the “other portion” means a portion in which the interval of tape materials is the interval applied across the widest range in the molding (the separation distance between adjacent tape materials in a plan view, the separation distance between tape materials in a cross-sectional view). The density of the fiber material in the “other portion” may be uniform, or may be non-uniform, for example.

It is not always required that the density of the fiber material in the fiber low-density portion be the lowest in the molding. That is, the molding of the present teaching encompasses a molding that partially includes, in addition to the fiber low-density portion, a portion having a lower density of the fiber material than that in the fiber low-density portion, for example.

In a case where the fiber material is a knitting yarn, the wording “the fiber low-density portion includes a portion having a stitch larger than the stitch of the other portion” means that the fiber low-density portion includes a portion having a stitch larger than the stitch with a size that is applied across the widest range in the molding (the standard stitch size in most of the molding), for example. It is not always required that the stitch included in the fiber low-density portion be largest in the molding. That is, the molding of the present teaching encompasses a molding that partially includes, in addition to the fiber low-density portion, a portion having a stitch larger than the stitch in the fiber low-density portion, for example.

In a case where the fiber material is a tape material, the “fiber low-density portion in which the density of the fiber material in the molding is lower as compared to in another portion” means that the fiber low-density portion includes a portion having a larger interval of tape materials than the interval of tape materials applied across the widest range in the molding (the standard tape material interval in most of the molding), for example. In a case where the fiber material is a tape material, it is not always required that the density of the tape material in the fiber low-density portion be the lowest in the molding. That is, the molding of the present teaching encompasses a molding that partially includes, in addition to the fiber low-density portion, a portion having a lower density of the tape material than the density of the tape material in the fiber low-density portion, for example.

The size of the stitch can be selected as appropriate in accordance with the type, shape, and size of its component, etc. To increase the size of the stitch in the fiber low-density portion, it is desirable that the size of the stitch in the fiber low-density portion and the size of the stitch in the other portion are different to such a degree that they can be visually recognized as different patterns. For example, the length of the knitting yarn that forms one stitch in the fiber low-density portion is preferably 150% or more of the length of the knitting yarn that forms one stitch in the other portion. Such a configuration makes it easy that the stitch in the fiber low-density portion and the stitch in the other portion can be visually recognized as different patterns. The length of the knitting yarn that forms one stitch in the fiber low-density portion is further preferably 150% or more and 300% or less of the length of the knitting yarn that forms one stitch in the other portion. Such a configuration makes it easy to find the terminal end portion of the knitting yarn.

As described above, the molding of the present teaching is configured to include the fiber low-density portion and the other portion. As described above, it is preferable that the other portion and the fiber low-density portion have different densities of the fiber material to such a degree that they can be visually recognized as different patterns before the resin material is melted or decomposed, for example. For example, in a case where the fiber material is a knitting yarn, it is preferable that the fiber low-density portion and the other portion have such a difference that their appearance can be recognized as different patterns such as a portion (the other portion) having a smaller stitch and a portion (the fiber low-density portion) having a larger stitch. For example, in a case where the fiber material is a knitting yarn, it is preferable that the fiber low-density portion and the other portion can be visually recognized to have different densities of the fiber material due to a difference between a portion(the other portion) including a stitch and a protruding portion (the fiber low-density portion) including an end portion disposed on a surface of the knitted substrate, for example. For example, in a case where the fiber material is a tape material, it is preferable that the fiber low-density portion and the other portion can be visually recognized to have different densities of the fiber material due to a difference between a portion (the other portion) having the tape materials arranged at substantially constant intervals and a protruding portion (the fiber low-density portion) including an end portion disposed apart from another tape material by a film material or the like.

The fiber low-density portion is defined in a range of a predetermined distance from the end of the fiber material in the molding, for example. The predetermined distance is the length of the end portion, for example. The predetermined distance is a length that allows the end portion of the fiber material to be grasped, for example. The grasping of the end portion is implemented by a grasping device, for example. In a case where the fiber material is formed as a knitted substrate, the fiber low-density portion can be defined as a portion including a length of the fiber material that allows the fiber material to be grasped from its end, for example. In a case where the fiber material is a knitting yarn, the fiber low-density portion can be defined as a portion including a length of the knitting yarn that allows the knitting yarn to be grasped from its end, for example. In a case where the fiber material is a knitting yarn, the fiber low-density portion can be defined as a portion in which a stitch formed by a graspable length of the knitting yarn is larger than a stitch in another portion, for example. In a case where the fiber material is a tape material, the fiber low-density portion can be defined as a portion including a length of the tape material that allows the tape material to be grasped from its end, for example.

The fiber low-density portion is provided so as to at least partially include at least a part of the surface of the molding, for example. For example, the fiber low-density portion is provided so as to at least partially include a portion (such as a protruding portion) formed by raising of the surface of the molding. The fiber low-density portion may be at least partially provided inside the molding, for example. For example, suppose that in the thickness direction of the molding, a position close to the surface of the molding is an upper layer, and a position deeper than the upper layer is a lower layer (inside the molding). In this case, the fiber low-density portion may be at least partially provided in the lower layer. For example, the fiber low-density portion may be formed adjacent to another portion in the lower layer of the molding. The fiber low-density portion may be provided partially in the thickness direction of the molding. For example, the fiber low-density portion may be provided throughout the thickness direction.

The molding can be a component part of anything. For example, the molding is applicable to various things, such as a component of a boat, a blade, a component of a drone, and the like. For example, the molding may be a product itself (final product).

For the method for manufacturing the molding, various choices are available in accordance with a configuration of the fiber material, the shape and size of a molded product, and the like. Examples of the choices include a technique of setting fiber materials not impregnated with resin to a mold and injecting a resin thereto, and a technique of laminating fiber materials.

Examples of the technique of setting fiber materials to a mold and injecting a resin thereto include a resin transfer molding (RTM) process and a vacuum-assisted resin transfer molding (VaRTM) process. The RTM process is a process of molding a mold, including: setting fiber materials to a mold; closing the mold including an upper mold and a lower mold; injecting a resin into a cavity in the mold; impregnating the fiber materials with the resin, and then hardening it in the mold. The VaRTM process is a process of impregnating fiber materials with a resin through vacuum suction by using only a lower mold and covering an upper surface with a vacuum bagging film.

Examples of the technique of laminating fiber materials include a tape winding process, a sheet winding process, and an autoclaving process. The tape winding process is a process including: winding a tape-shaped prepreg on a core metal called mandrel, the tape-shaped prepreg having fiber materials impregnated with a resin; then additionally winding a heat shrink tape; and heating the mandrel as a whole, for hardening. The sheet winding process is a process including: winding a sheet-shaped prepreg on a mandrel; then additionally winding a heat shrink tape; heating the mandrel as a whole, for hardening. The autoclaving process is a process including: laminating sheet-shaped prepregs in a mold; and hardening a resin with heating, pressure application, and vacuum drawing by using an autoclave (pressure vessel).

### Advantageous Effects of Invention

The present teaching can provide a molding of a fiber-reinforced composite material in which the fiber material can be easily recovered and enables broader use when reused.

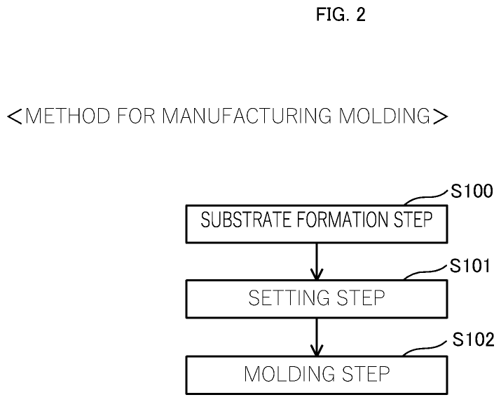

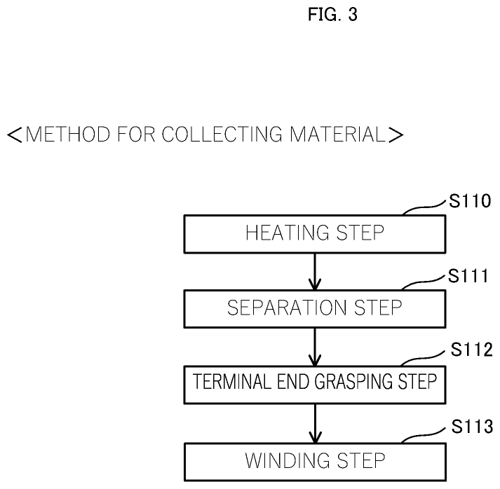

### BRIEF DESCRIPTION OF DRAWINGS

[FIG. 1A, FIG. 1B, and FIG. 1C] Diagrams showing a molding according to first embodiment of the present teaching, including: FIG. 1A a schematic diagram showing a principal part of the molding; FIG. 1B a diagram showing a state where a resin material of the molding is melted; and FIG. 1C a diagram showing stitches of a knitted substrate

[FIG. 2] A diagram showing a method for manufacturing the molding of FIG. 1A, FIG. 1B, and FIG. 1C

[FIG. 3] A diagram showing a method for recovering a material from the molding of FIG. 1A, FIG. 1B, and FIG. 1C

[FIG. 4A, FIG. 4B, FIG. 4C, and FIG. 4D] Diagrams showing a variation of the molding of FIG. 1A, FIG. 1B, and FIG. 1C

[FIG. 5A and FIG. 5B] Diagrams showing a principal part of a molding according to second embodiment of the present teaching

### DESCRIPTION OF EMBODIMENTS

In the following, details of moldings according to embodiments of the present teaching will be described with reference to the drawings. Here, it should be noted that the embodiments described below are merely examples. The present teaching should not be construed as being limited in any way by the embodiments described below.

### First Embodiment

Referring to FIG. 1A, FIG. 1B, and FIG. 1C, a configuration of a molding 1 according to first embodiment of the present teaching will be described. FIG. 1A, FIG. 1B, and FIG. 1C are diagrams including: a schematic diagram showing a principal part of the molding 1; a diagram showing a state after a resin material of the molding is melted; and a diagram showing stitches 23a formed in a knitted substrate 22 of the molding 1.

The molding 1 is a molding of a fiber-reinforced composite material, which includes a fiber material 20 as a reinforcement and a resin material 10 as a base material. Adopted as the resin material 10 in the molding 1 of this embodiment is a thermoplastic resin capable of being melted by heat. Adopted as the fiber material 20 in the molding 1 of this embodiment is a natural fiber. As shown in FIG. 1A, the molding 1 of this embodiment includes plural knitted substrates 22. To be specific, the molding 1 is formed of three knitted substrates 22 stacked and molded. In the molding 1 of this embodiment, the knitted substrates 22 are configured such that one knitted substrate 22 has a three-dimensional shape that conforms to the shape of the molding 1.

In the molding 1 of this embodiment, the fiber material 20 is a knitting yarn 21. The knitting yarn 21 (fiber material 20) is buried in the resin material 10 while being continuous so as to form a shape according to the resin material 10. More specifically, the knitting yarn 21 is in the shape of a continuous filament, and is formed as the knitted substrate 22, which will be described later. Thus, in the molding 1, the knitting yarn 21 (knitted substrate 22) is buried in the resin material 10 over a most part of the molding 1 forming the outer shape of a product.

The knitting yarn 21 (fiber material 20) is buried in the resin material 10 in such a manner that the shape (knitted substrate 22) formed by the knitting yarn 21 can be unraveled and the knitting yarn 21 can be recovered by taking out a terminal end portion 24a of the knitting yarn 21. Moreover, the knitting yarn 21 is configured such that when the resin material 10 is melted, the terminal end portion 24a becomes identifiable and the terminal end portion 24a can be positioned in a fiber low-density portion 2.

As mentioned above, in the molding 1 of this embodiment, the fiber material 20 is the knitting yarn 21 with a filamentous shape. The knitting yarn 21 is formed by stranding (twisting) a bundle of natural fibers. The knitting yarn 21 is formed as the knitted substrate 22.

The knitted substrate 22 will be described in detail with reference to FIG. 1C. In the following description, the direction (in FIG. 1C, the lateral direction) in which the knitting yarn 21 is supplied may sometimes be referred to simply as “course direction X,” and a direction that crosses the course direction X may sometimes be referred to simply as “wale direction Y” (in FIG. 1C, the longitudinal direction).

As shown in FIG. 1C, the knitting yarn 21 forms a stitch 23a, which has a loop shape. To be specific, the knitting yarn 21 forms plural stitches 23a arrayed in the course direction X. The knitting yarn 21 also forms a cross-over portion 23b between one stitch 23a and another stitch 23a. In this manner, the knitting yarn 21 is formed as the knitted substrate 22 in which plural stitches 23a are formed in the course direction X and in the wale direction Y.

As shown in FIG. 1A, the molding 1 has the fiber low-density portion 2. The fiber low-density portion 2 is a portion where the density of the knitting yarn 21 is lower than that in the other portion. As shown in FIG. 1A, the fiber low-density portion 2 includes a protruding portion 3, which is formed by bulging of a surface F of the molding 1. In the molding 1 of this embodiment, the protruding portion 3 has such a shape that the surface F of the molding 1 is raised into a dome shape.

As shown in FIG. 1A, in the molding 1 of this embodiment, a knot 27 created by tying the knitting yarn 21 is provided near the terminal end portion 24a. As shown in FIG. 1A, in the molding 1 of this embodiment, the knot 27 near the terminal end portion 24a is an overhand knot disposed at the base of a ring portion 28 formed by shaping the knitting yarn 21 into a ring.

Next, the fiber low-density portion 2 will be described in more detail. In the molding 1 of this embodiment, provided as the fiber low-density portion 2, which is a portion in which the density of the knitting yarn 21 in the molding 1 is lower as compared to in the other portion, are the protruding portion 3 and a portion (loose knitting portion 26) in which the stitch 23a is larger as compared to in the other portion.

To be specific, as shown in FIG. 1A, a portion of the knitted substrate 22 near the terminal end portion 24a is the loose knitting portion 26 in which the stitch 23a is larger as compared to in the other portion. In a portion (dense knitting portion 25) of the knitted substrate 22 except the loose knitting portion 26, the size of the stitch 23a is normal in the knitted substrate 22. Thus, the loose knitting portion 26 can be considered to be a portion in which the stitch 23a is larger as compared to in the dense knitting portion 25 and the density of the knitting yarn 21 in the molding 1 is lower as compared to in the dense knitting portion 25. That is, the loose knitting portion 26 is included in the fiber low-density portion 2. In the description below, a portion in which the stitch 23a is smaller as compared to in the loose knitting portion 26 may sometimes be expressed as the “dense knitting portion 25.”

The protruding portion 3 is a portion that includes the terminal end portion 24a, the ring portion 28, and the knot 27, but does not include the stitch 23a. Thus, the protruding portion 3 can be considered as a portion in which no stitch 23a is included and the density of the knitting yarn 21 in the molding 1 is lower as compared to in the other portion (dense knitting portion 25). That is, the protruding portion 3 is included in the fiber low-density portion 2.

In the molding 1 of this embodiment, the protruding portion 3 and the loose knitting portion 26 are included in the fiber low-density portion 2. In other words, in the molding 1 of this embodiment, the fiber low-density portion 2 includes both a portion (loose knitting portion 26) in which the stitch 23a is larger than the stitch 23a in the other portion and a portion (protruding portion 3) in which no stitch 23a is present. The density of the knitting yarn 21 in the molding 1 increases in the order of “protruding portion 3<loose knitting portion 26<dense knitting portion 25.”

Next, a state after the resin material 10 of the molding 1 is melted will be described with reference to FIG. 1B. As shown in FIG. 1B, in the molding 1, the portion (loose knitting portion 26) in which the stitch is larger as compared to in the dense knitting portion 25 (the other portion) is provided such that after the resin material 10 is melted, the terminal end portion 24a is positioned in the loose knitting portion 26. In the molding 1, therefore, the terminal end portion 24a, which is positioned in the protruding portion 3 (fiber low-density portion 2) before the resin material 10 is melted, is positioned in the loose knitting portion 26 after the resin material 10 is melted. Consequently, after the resin material 10 is melted, a difference in size of the stitch 23a makes it easy to identify the dense knitting portion 25 from the terminal end portion 24a and the loose knitting portion 26.

### [Method for Manufacturing Molding of First Embodiment]

Next, a method for manufacturing the molding 1 will be described. The molding 1 of this embodiment is molded by setting the knitted substrate 22 in a mold and then injecting the resin material 10 into the mold.

FIG. 2 shows the steps of manufacturing the molding 1. In this embodiment, a case of molding the molding 1 through an RTM process will be illustrated as an example. As shown in FIG. 2, the method for manufacturing the molding 1 includes at least substrate formation step S100, setting step S101, and molding step S102. The steps included in the method for manufacturing the molding 1 are performed in the order of the substrate formation step S100, the setting step S101, and the molding step S102.

The substrate formation step S100 is a step of forming the knitted substrate 22 by knitting the knitting yarn 21 with a knitting machine (not shown). To be specific, in the substrate formation step S100, by using the knitting machine, the knitting yarn 21 is looped, and the knitting yarn 21 is threaded through the looped portion so that the looped portion (stitch 23a) is created one after another. In this manner, the knitted substrate 22 is formed in which the stitches 23a are created consecutively.

The setting step S101 is a step of setting the knitted substrate 22 in a mold (not shown). The mold includes an upper mold and a lower mold. While the upper mold and the lower mold are separated, the knitted substrate 22 is set in the lower mold. After the knitted substrate 22 is set in the lower mold, mold-clamping is performed for clamping the mold. As a result of the mold-clamping, a gap (cavity) into which the resin material 10 is injected appears in the mold.

In the molding step S102, the resin material 10 is injected into the cavity. After the resin material 10 is injected into the cavity, the resin material 10 gradually hardens as time elapses. After the hardening of the resin material 10, mold-opening is performed so that the molding 1 is taken out of the mold.

### [Method for Recovering Material]

Next, a method for recovering the knitting yarn 21 and the resin material 10 from the molding 1 will be described. As shown in FIG. 3, the step of recovering the knitting yarn 21 and the resin material 10 from the molding 1 includes at least heating step S110, separation step S111, terminal end grasping step S112, and winding step S113. The steps for recovering the materials of the molding 1 are performed in the order of the heating step S110, the separation step S111, the terminal end grasping step S112, and the winding step S113.

In the heating step S110, a process of heating the molding 1 is carried out. More specifically, in the heating step S110, the resin material 10 contained in the molding 1 is heated and melted. As a result of melting of the resin material 10 of the molding 1 in the heating step S110, the knitting yarn 21 and the resin material 10 are able to be separated from each other. Here, in a case of using a thermosetting resin as the resin material, a decomposition step of decomposing the thermosetting resin through chemical decomposition with chemicals or superheated steam decomposition may be adopted instead of the heating step.

In the separation step S111, a process of separating the knitting yarn 21 from the resin material 10 is carried out. Specifically, in the separation step S111, the knitting yarn 21 is separated from the resin material 10, which is melted, by a centrifuge (not shown). After being separated, the knitting yarn 21 and the resin material 10 are each subjected to a process for reuse. The knitting yarn 21 undergoes the terminal end grasping step S112 and the winding step S113, which will be described below, to be reused as a knitting yarn again.

In the terminal end grasping step S112, a process of grasping the terminal end portion 24a of the knitting yarn 21 and setting it in a winding machine (not shown) is carried out. As described above, the molding 1 is configured such that the stitch 23a is larger in the fiber low-density portion 2 including the terminal end portion 24 than in the other portion. In other words, in the other portion excluding the surroundings of the terminal end portion 24a, the stitch 23a is small, and the knitting yarn 21 is densely packed, while in the surroundings of the terminal end portion 24a, the stitch 23a is large, and the knitting yarn 21 is sparse. This makes it easy to find the terminal end portion 24a of the knitting yarn 21 in the knitted substrate 22 after the knitting yarn 21 is separated from the resin material 10, and thus to grasp the terminal end portion 24a in the molding 1.

In the winding step S113, a process of unraveling the stitch 23a of the knitted substrate 22 while pulling the terminal end portion 24a, and winding the knitting yarn 21 is carried out. The knitting yarn 21 is recovered with its length maintained. This expands the application of the recovered knitting yarn 21.

### [First Variation]

Next, first variation of the molding 1 according to the first embodiment will be described. In a case where the fiber material of the molding of the present teaching is a knitting yarn, a configuration illustrated in FIG. 4A may be adopted. To be specific, in a molding 30 shown in FIG. 4A, a fiber low-density portion 32 is a flat portion including no protruding portion. In the molding 30, a stitch 23a in the fiber low-density portion 32 is larger as compared to that in the other portion. The molding 30 is configured such that after a resin material 10 is melted, a terminal end portion 24a is positioned in a portion (loose knitting portion 26) in which the stitch 23a is larger. With this configuration, in the molding 30, after the resin material 10 is melted, the stitches 23a in the dense knitting portion 25, the terminal end portion 24a, and the loose knitting portion 26 where the terminal end portion 24a is located can be distinguished.

### [Second Variation]

Next, second variation of the molding 1 according to the first embodiment will be described. In a case where the fiber material of the molding of the present teaching is a knitting yarn, a configuration illustrated in FIG. 4B may be adopted. To be specific, in a molding 40 shown in FIG. 4B, a fiber low-density portion 42 is a flat portion including no protruding portion. In the molding 40, the knitted substrate 22 has a hole 43 where no stitch 23a is present, and a terminal end portion 24a is disposed in the hole 43. In the molding 40, the amount of a knitting yarn 21 (a ring portion 28, a knot 27, and the terminal end portion 24a) disposed in the hole 43 is smaller than that in the other portion (a knitted fabric portion 29 where the stitch 23a is present). Thus, in the molding 40, the hole 43 serves as the fiber low-density portion 42 in which the density of the knitting yarn 21 in the molding 40 is lower.

The molding 40 is configured such that after a resin material 10 is melted, the terminal end portion 24a is positioned in the hole 43. With this configuration, in the molding 40, after the resin material 10 is melted, the knitted fabric portion 29, and the terminal end portion 24a and the hole 43, can be distinguished.

### [Third Variation]

Next, third variation of the molding 1 according to the first embodiment will be described. In a case where the fiber material of the molding of the present teaching is a knitting yarn, a configuration illustrated in FIG. 4C may be adopted. To be specific, a molding 50 shown in FIG. 4C includes a protruding portion 53 having a ring shape. In the molding 50, a terminal end portion 24a of a knitting yarn 21 is shaped into a ring shape to form a ring portion 28, and a knot 27 of the knitting yarn 21 is an overhand knot disposed at the base of the ring portion 28. In the molding 50, a portion (loose knitting portion 26) in which the stitch 23a is larger than that in the other portion, and the protruding portion 53 in which the ring portion 28 is accommodated, are provided as the fiber low-density portion 52 in which the density of the knitting yarn 21 in the molding 50 is lower as compared to in the other portion.

The molding 50 is configured such that after a resin material 10 is melted, the terminal end portion 24a is positioned in a portion (loose knitting portion 26) in which the stitch 23a is larger. With this configuration, in the molding 50, after the resin material 10 is melted, the stitches 23a in the dense knitting portion 25, the terminal end portion 24a, and the loose knitting portion 26 where the terminal end portion 24a is located can be distinguished.

### [Fourth Variation]

Next, fourth variation of the molding 1 according to the first embodiment will be described. In a case where the fiber material of the molding of the present teaching is a knitting yarn, a configuration illustrated in FIG. 4D may be adopted. To be specific, a molding 60 shown in FIG. 4D includes a protruding portion 63 formed in a raised fashion. In the molding 60, a terminal end portion 24a of a knitting yarn 21 is shaped into a ring shape to form a ring portion 28, and a knot 27 of the knitting yarn 21 is an overhand knot disposed at the base of the ring portion 28. The terminal end portion 24a is accommodated in the protruding portion 63. In the molding 60, the amount of a knitting yarn 21 (the ring portion 28, the knot 27, and the terminal end portion 24a) disposed in the protruding portion 63 is smaller than that in the other portion (a knitted fabric portion 29 where a stitch 23a is present). Thus, in the molding 60, the protruding portion 63 serves as a fiber low-density portion 62 in which the density of the knitting yarn 21 in the molding 60 is lower.

The molding 60 is configured such that after a resin material 10 is melted, the terminal end portion 24a is exposed and positioned on a surface of a knitted substrate 22. With this configuration, in the molding 60, after the resin material 10 is melted, the terminal end portion 24a is able to be identified from the knitted fabric portion 29.

### Second Embodiment

Next, a configuration of a molding 70 according to second embodiment of the present teaching will be described with reference to FIG. 5A and FIG. 5B. FIG. 5A is a cross-sectional view showing a principal part of the molding 70. FIG. 5B is a plan view showing a principal part of the molding 70.

The molding 70 is a molding of a fiber-reinforced composite material, which includes a fiber material 20 as a reinforcement and a resin material 10 as a base material. Adopted as the resin material 10 in the molding 70 of this embodiment is a thermoplastic resin capable of being melted by heat. In the molding 70 of this embodiment, the fiber material 20 is a tape material 73 including carbon fibers formed in a sheet-like shape. The molding 70 is obtained by molding a lamination of tape-shaped prepregs each made of the tape material 73 impregnated with the resin material 10. As shown in FIGS. 5A and 5B, the molding 70 has a fiber low-density portion 72.

As shown in FIG. 5A, a terminal end portion 74a of the tape material 73 is covered with a film material 75. In the vicinity of the terminal end portion 74a of the tape material 73, a larger amount of the resin material 10 as compared to in the other portion is present, to form a protrusion (to form a protruding portion 72a). Accordingly, in the molding 70, the proportion (density) of the tape material 73 in the molding 70 is lower in a portion (the fiber low-density portion 72) near the terminal end portion 74a of the tape material 73 than in the other portion (the density of the tape material 73: the fiber low-density portion<the other portion).

As shown in FIG. 5B, in the molding 70, in a portion having no terminal end portion 74a, the tape materials 73 are laminated at substantially constant intervals so as to extend in paths that have substantially the same angle, whereas in a portion having the terminal end portion 74a, the tape material 73 extends in a path that is bent and thus different from the paths of the other tape materials 73. In the molding 70, therefore, after the resin material 10 is melted, the tape materials 73 in the other portion are arranged at substantially uniform intervals and angles, whereas the tape material 73 in the terminal end portion 74a forms a different angle. With this configuration, in the molding 70, after the resin material 10 is melted, the other portion is able to be identified from the portion (a portion that was the protruding portion 72a) where the terminal end portion 74a is positioned.

### REFERENCE SIGNS LIST

1 molding
2 fiber low-density portion
3 protruding portion (fiber low-density portion)
10 resin material
20 fiber material
21 knitting yarn (fiber material)
22 knitted substrate
23a stitch
24a terminal end portion (end portion)
25 dense knitting portion (another portion)
26 loose knitting portion (fiber low-density portion)
27 knot
28 ring portion
30 molding
32 fiber low-density portion
40 molding
42 fiber low-density portion
43 hole (fiber low-density portion)
50 molding
52 fiber low-density portion
53 protruding portion (fiber low-density portion)
60 molding
62 fiber low-density portion
63 protruding portion (fiber low-density portion)
70 molding
72 fiber low-density portion
73 tape material (fiber material)
74a terminal end portion (end portion)

1. A molding of a fiber-reinforced composite material comprising:
a resin material that is meltable or decomposable; and
a fiber material that is continuous between a start end portion thereof and a terminal end portion thereof, and forms a shape that is unravelable by taking an end portion thereof that is either the start end portion or the terminal end portion, wherein
the fiber material is buried in the resin material,
the molding has a fiber low-density portion in which a density of the fiber material is lower than in the rest of the molding, and
the end portion of the fiber material is positioned in the fiber low-density portion so as to be identifiable.

2. The molding according to claim 1, wherein
the fiber low-density portion includes a protruding portion protruding on a surface of the molding, and
the end portion of the fiber material is positioned in the protruding portion, and is identifiable either before or after the resin material is melted or decomposed.

3. The molding according to claim 2, wherein
the end portion of the fiber material is positioned in the protruding portion protruding with a hook shape or a ring shape on the surface of the molding.

4. The molding according to claim 1, wherein
the fiber material is a knitting yarn of a filamentous shape,
the knitting yarn forms a knitted substrate in which a plurality of stitches are continuously arranged, each of the stitches being formed by shaping the knitting yarn into a loop, and
the terminal end portion of the knitting yarn is positioned in the fiber low-density portion.

5. The molding according to claim 4, wherein
the fiber low-density portion includes a loose knitting portion,
the plurality of stitches includes one stitch that is in the loose knitting portion and is larger than the other stitches, and
the terminal end portion of the knitting yarn is positioned in the loose knitting portion.

6. The molding according to claim 4, wherein
the terminal end portion of the knitting yarn has a knot created by tying the knitting yarn.

7. The molding according to claim 6, wherein
the knot is an overhand knot created at a base of a ring portion of the knitting yarn formed by shaping the knitting yarn into a ring.

8. The molding according to claim 4, wherein
the knitted substrate has a three-dimensional shape in which the plurality of stitches are continuously arranged.
